(19) United States
(12) Patent Application Publication
(10) Pub. No.: US 2006/0046833 A1
(43) Pub. Date: Mar. 2, 2006

(54) Gaming machine deciding a continuation of a special play mode by a lottery

(75) Inventors: Daisuke Hatakeyama, Tokyo (JP); Hirokazu Kitani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 11/209,772

(22) Filed: Aug. 24, 2005

(30) Foreign Application Priority Data
Aug. 26, 2004 (JP) 2004-247177
Oct. 27, 2004 (JP) 2004-312522

(51) Int. Cl. A63F 13/00

(52) U.S. Cl. 463/20

(57) ABSTRACT

A gaming machine which adds a bonus game capable of giving a strong impression to a player. This gaming machine comprises: a shift determination device for shifting, in case symbols in a stopped variable display state contain a predetermined symbol combination, a play mode from a base play mode to a special play mode for making the payment of variables beneficial to the player; and a continuation determination device for determining whether or not the special play mode is to be continued, at the end of the special play mode, to continue the special play mode in accordance with the result of a lottery.

### CROSS-REFERENCE TO THE RELATED APPLICATION(S)

This application is based upon and claims a priority from the prior Japanese Patent Applications No. 2004-247177 filed on Aug. 26, 2004 and No. 2004-312522 filed on Oct. 27, 2004, and the entire contents of which are incorporated herein by reference.

### BACKGROUND OF THE INVENTION

1. Field of the Invention

The present invention relates to a gaming machine and, more particularly, to a gaming machine which decides it by a lottery whether or not a special play mode for giving a benefit to the player is to be continued, so that the special play mode is continued according to the result of the lottery.

2. Description of Related Art

A slot machine is a gaming machine for paying back media (as will be called the “coins”) to be used in the game, such as medals or coins. When the player does a predetermined operation, individual reels start scrolling so that symbols arranged in a predetermined sequence are cyclically displayed. In case, moreover, stop symbols or the symbols displayed with all reels being stopped take a predetermined symbol combination for a win, the coins are paid out according to the winning combination.

Some slot machine allows the player to play a bonus game, which gives a higher award to acquire the coins than the base game, in case a predetermined condition is satisfied by the array of special symbols (bonus trigger) on an activated line.

In one mode of this bonus game, a free spin capable of acquiring a rotation of each reel and a chance of the lottery without consuming the coins is played a predetermined number by the player. Of the gaming machines providing the free spins, there has been devised a gaming machine (e.g., Patent Publication 1), which has a function called the “re-trigger” for allowing the player to play the free spin again, if a predetermined number of or more bonus triggers are arranged during the free spins.

Patent Publication 1: JP-A-2003-180908 (Para [0044], FIG. 1)

In the play by the slot machine thus far described, the re-trigger for reopening the bonus game occurs at a timing unexpected by the player, so that it seems to give a high impact to the player.

However, it is a factor exerting serious influences on the increase/decrease of the number of coins to be acquired by the player whether or not the bonus game is to be reopened. The re-opening of the bonus game may reduce, if impossible, the player's interest in continuation of the game.

Generally, the probability of the symbol combination for the re-trigger is set so low that the symbol combination for the re-trigger is scarcely stopped during the free spins. Therefore, the effects of causing the player to note the stop symbols and attracting the attention of the player may hardly be expected.

In the presence of the benefits to add the bonus game, however, there is a problem that the number of players to be stimulated to more plays is not increased, as expected.

The present invention contemplates to provide a gaming machine, which can continue the playing intention of a player irrespective of whether or not a bonus game for making the acquirement of coins beneficial to the player is added.

### SUMMARY OF THE INVENTION

The invention has the following characteristics as means for solving the aforementioned problems.

A first aspect of the invention is proposed as a gaming machine. This gaming machine comprises: a symbol display device (e.g., a display) including a plurality of symbol display units capable of variably displaying a plurality of continuous symbols, for displaying at least one of the plural continuous symbols in each of the symbol display units when the variable display is stopped according to a predetermined variable stop condition; a shift determination device (e.g., a main CPU) for determining whether or not the symbols displayed in the individual symbol display units in a stopped variable display state contain a predetermined symbol combination, to shift, in case the displayed symbols contain the predetermined symbol combination, a play mode from a base play mode into a special play mode, in which the payment of the valuables is made more beneficial than in the base play mode; and a continuation determination device (e.g., a main CPU) for determining whether or not the special play mode is to be continued, at the end of the special play mode, to continue the special play mode in accordance with the result of a lottery.

The aforementioned word “valuables” implies realizable values or the irrealizable values having some merits, and may be either tangibles such as the medals, coins or chips (as will be generally called the “coins”) to be used in the parlor, game arcad or casino, or intangibles such as credits or the information enumerated from the number of coins.

Herein, the phrase “combination of symbols” is a concept containing not only a plurality of symbols but also one specific symbol. The concept of “symbol combination” may specify the sequence of symbols arrayed or may not.

According to this mode of the invention, the continuation of the special play mode is decided at the end of the special play mode. After the player enjoyed all the benefits of the special play mode, the continuation is decided so that the player does not lose the benefits. Thus, the gaming machine can continue the playing intention of the player no matter whether or not the bonus game to make the acquirement of coins beneficial to the player might be added.

A second mode of the invention is proposed as a gaming machine.

This gaming machine comprises: a symbol display device (e.g., a display) including a plurality of symbol display units capable of variably displaying a plurality of continuous symbols, for displaying at least one of the plural continuous symbols in each of the symbol display units when the variable display is stopped according to a predetermined variable stop condition; a first special play mode execution device (e.g., a main CPU) for executing a first special play mode (e.g., a first bonus game), in which the payment of the variables is made more beneficial to the player than in the ordinary play state and which contains the variable displays of a first prescribed number; a second special play mode execution device (e.g., a main CPU) for executing a second special play mode (e.g., a second bonus game), in which the payment of the variables is made more beneficial to the player than in the ordinary play state, which has play contents other than those of the first play mode and which contains the variable displays of a second prescribed number; and a shift determination device (e.g., a main CPU) for determining, in the variable display of the first prescribed number or the variable display of the second prescribed number, whether or not the symbols displayed in the individual symbol display units in the stopped variable display state, to cause, in case the displayed symbols contain the predetermined symbol combination, the first special play mode execution device or the second special play mode execution device to execute the first special play mode or the second special play mode in accordance with the predetermined symbols contained.

Individually in the first special play mode and the second special play mode, according to the gaming machine, the stop symbols are displayed in the first prescribed number or the second prescribed number. As a result, the shift to the first special play mode or the second special play mode occurs, in case the symbols for the starting condition for the first or second special play mode appear completely. Therefore, the so-called “link” from a bonus game to a bonus game occurs and supports the acquirement of such a chance by the player as to gain more valuables. As a result, it is possible to improve the player's intentions to start and continue the game.

According to this mode of the invention, it is possible to provide a gaming machine, which can make possible the continuation/addition/link of the bonus game for making the acquirement of coins beneficial to the player, so that it can keep and intensify the player's interest in the game.

### BRIEF DESCRIPTION OF THE DRAWINGS

FIG. 1 is a perspective view showing the appearance of a slot machine according to an embodiment of the invention;

FIG. 2 is a diagram showing a button arrangement of a control panel;

FIG. 3 is a block diagram showing the slot machine while centering the internal configuration;

FIG. 4 is a block diagram showing one example of the internal configuration of an image control circuit;

FIG. 5 is a diagram showing a display screen of a display;

FIG. 6 is a diagram showing symbols displayed in the display;

FIGS. 7A and 7B are diagrams showing examples of the pay lines of the slot machine;

FIG. 8 is a diagram showing symbol arrays of the slot machine according to the embodiment;

FIG. 9 is a flow chart showing a game progress of the slot machine;

FIG. 10 is a flow chart showing an example of a feature game process;

FIG. 11 is a flow chart showing an example of a free spin process;

FIG. 12 is a flow chart showing an example of a feature game continuation process;

FIG. 13 is a flow chart showing an example of an additional free spin number determination process;

FIG. 14 is a diagram showing a display screen of a lottery acceptance interface;

FIG. 15 is a diagram showing the display screen of the lottery acceptance interface and subsequent to FIG. 14;

FIG. 16 is a diagram showing the display screen of the display and subsequent to the screen of FIG. 15;

FIG. 17 is a flow chart of a main process in a second embodiment;

FIG. 18 is a flow chart of a free spin process in the second embodiment;

FIG. 19 is a flow chart of a first bonus game process in the second embodiment;

FIG. 20 is a flow chart of a second bonus game process in the second embodiment;

FIG. 21 is a diagram showing a screen example in the second bonus game;

FIG. 22 is a diagram showing a screen example in the second bonus game subsequent to FIG. 21;

FIG. 23 is a diagram showing a screen example in the second bonus game subsequent to FIG. 22;

FIG. 24 is a diagram showing another screen example in the second bonus game subsequent to FIG. 22; and

FIG. 25 is a diagram showing still another screen example in the second bonus game subsequent to FIG. 22.

### DETAILED DESCRIPTION OF THE PREFERRED EMBODIMENTS

The best mode of the invention for carrying out a gaming machine according to the invention will be described in detail with reference to the accompanying drawings. Here, the identical or equivalent components are designated by common reference numerals, and their descriptions are omitted if they overlap each other.

### 1. First Embodiment

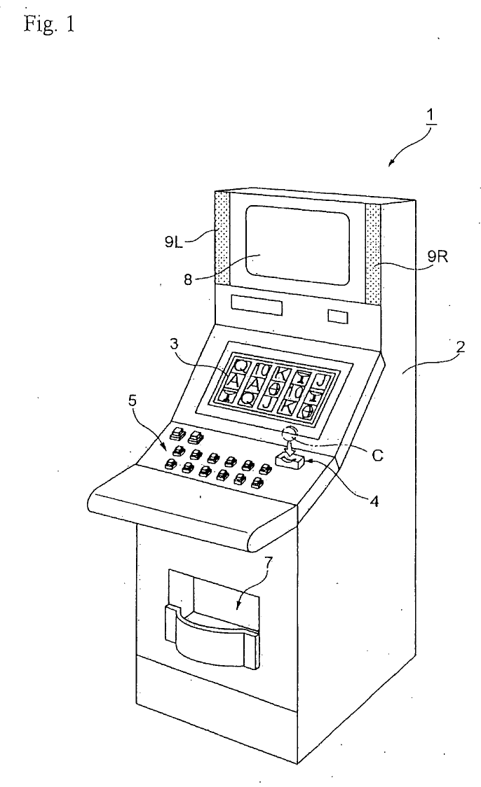

FIG. 1 is an overall perspective view showing a slot machine or a gaming machine according to a first embodiment. The slot machine 1 includes a cabinet 2, which is provided with a display 3 or symbol display means. The display 3 is a liquid crystal display for digitally displaying a slot game, for example. On this side below the display 3, there is disposed a coin insertion slot 4 for inserting coins. Here may also be suitably disposed a paper money insertion slot for playing the slot game with the paper money.

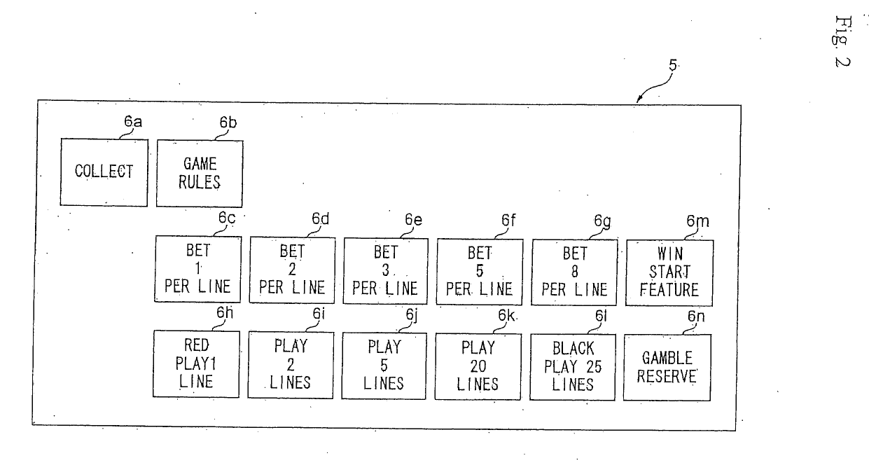

Below the display 3, there is disposed a control panel 5. This control panel 5 is substantially similar to that belonging to the well-known slot game, and is provided with fourteen buttons 6a to 6n, as shown in FIG. 2.

Specifically, the control panel 5 is provided, in the upper portion on the left side, with a collect button (COLLECT) 6a for fixing the coins acquired in the game, and a game rule button (GAME RULES) 6b for instructing execution of a help function. The remaining twelve buttons are arranged in two stages substantially at the center of the control panel 5: five betting buttons 6c to 6g for determining the number of coins bet (i.e, the bet number); five line buttons 6h to 6l for determining the line number; a start feature button (START FEATURE) 6m for a feature game (e.g., a game for plural free spins) or a first special play mode; and a gamble button (GAMBLE) 6n for determining the shift to a double game at the end of the feature game.

Reverting to FIG. 1, the cabinet 2 is provided in its lower portion with a coin tray 7 for the player to receive coins paid out. In FIG. 1, numeral 8 designates a subdisplay for displaying images (e.g., the explanation of game contents or the effects of the feature game) having no direct relation to the game, and numerals 9L and 9R designate a pair of speakers.

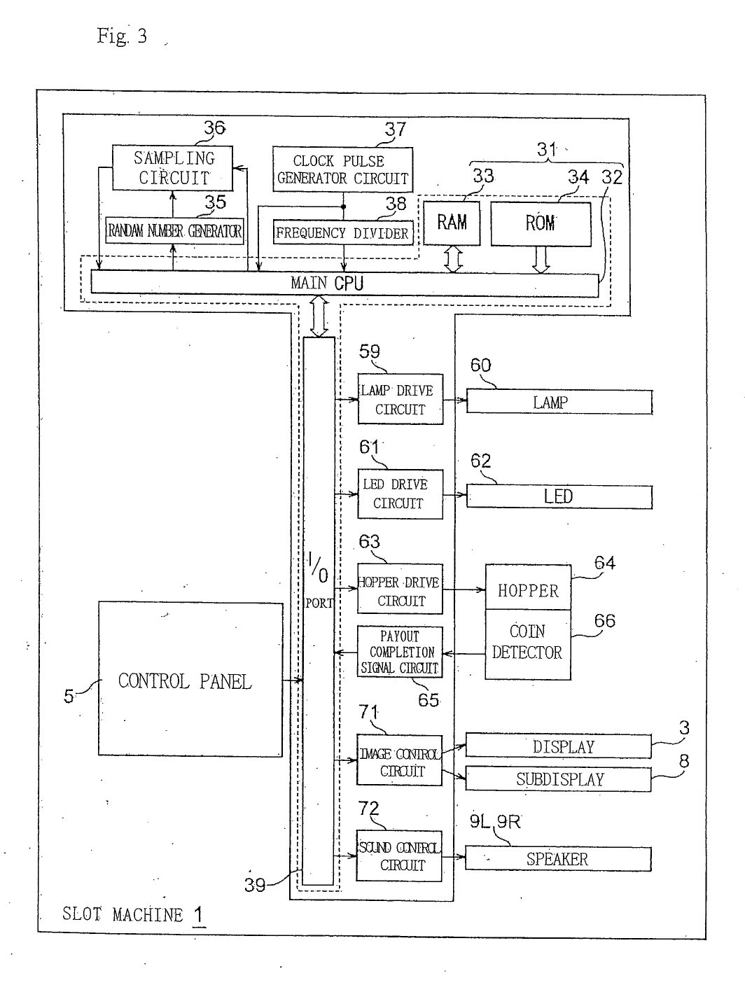

FIG. 3 is a block diagram showing the internal configuration of the slot machine 1. As shown in FIG. 3, the slot machine 1 is provided with a plurality of components around a microcomputer 31.

The microcomputer 31 includes a main CPU (Central Processing Unit) 32, a RAM (Random Access Memory) 33 and a ROM (Read Only Memory) 34.

In accordance with the program stored in the ROM 34, the main CPU 32 functions to input signals from the individual units of the control panel 5 through an I/O port 39 and to input/output signals with other components thereby to control the actions of the entire slot machine 1. The RAM 33 is stored with the data and program to be used for the main CPU 32 to function, and temporarily holds the random number values to be sampled by a later-described sampling circuit 36, for example, after the game starts. The ROM 34 is stored with the program to be executed by the main CPU 32, and the permanent data.

On the other hand, the slot machine 1 is provided with a random number generator 35, the sampling circuit 36, a clock pulse generator 37 and a frequency divider 38. In accordance with an instruction of the main CPU 32, the random number generator 35 functions to generate random numbers within a predetermined range. In accordance with an instruction of the main CPU 32, the sampling circuit 36 extracts arbitrary one from the random numbers generated by the random number generator 35, and inputs the extracted random number to the main CPU 32. The clock pulse generator 37 generates a reference clock to be utilized in the main CPU 32, and the frequency divider 38 inputs a signal, which is prepared by dividing the reference clock with a predetermined period, to the main CPU 32.

The slot machine 1 is further provided with a lamp drive circuit 59, a lamp 60, an LED drive circuit 61, an LED 62, a hopper drive circuit 63, a hopper 64, a payout completion signal circuit 65 and a coin detector 66. The slot machine 1 is further provided with an image control circuit 71 for controlling images to be displayed in the display 3 and the subdisplay 8, and a sound control circuit 72 for controlling the sound to be generated from the speakers 9L and 9R.

The lamp drive circuit 59 outputs a signal to the lamp 60 to turn the lamp 60 on, and turns on/off the lamp 60 during executing the game. This turning-on/off effects the game. The LED drive circuit 61 controls the flashing display of the LED 62. This LED 62 indicates the credit number, the acquisition number and so on.

In accordance with the control of the main CPU 32, the hopper drive circuit 63 drives the hopper 64, which acts to pay out the valuables or coins from the coin tray 7.

The coin detector 66 measures the number of coins paid out by the hopper 64 and informs the payout completion signal circuit 65 of the data of the measured number. The payout completion signal circuit 65 inputs the data of coin number from the coin detector 66, and inputs a signal informing the coin payout completion to the main CPU 32 when the coin number reaches the data of set number.

The image control circuit 71 controls the individual image displays in the display 3 and the subdisplay 8 so that the various images such as the later-described symbol images may be displayed by the display 3 and the subdisplay 8.

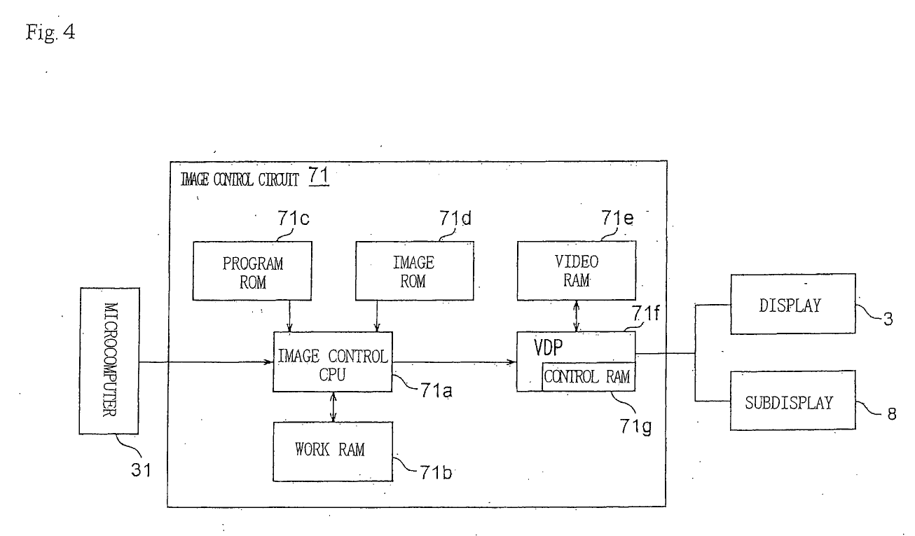

This image control circuit 71 is provided, as shown in FIG. 4, with an image control CPU 71a, a work RAM 71b, a program ROM 71c, an image ROM 71d, a video RAM 71e and a VDP (Video Display Processor) 71f. On the basis of parameters set by the microcomputer 31 and in accordance with the image control program prestored in the program ROM 71c, the image control CPU 71a determines the images (e.g., the symbol images) to be displayed in the display 3 and the subdisplay 8. The work RAM 71b is configured as temporary storage means for the image control CPU 71a to execute the image control program.

The program ROM 71c is stored with the image control program or the various selection tables. The image ROM 71d is stored with dot data for forming the images. In this embodiment, these dot data contain the data of the various symbol images (as will be called the “symbol image group”). The video RAM 71e is configured as temporary storage means for the VDP 71f to form the images. The VDP 71f has a control RAM 71g, and forms the images, which are determined by the image control CPU 71a and which accord to the display contents of the display 3 and the subdisplay 8, and outputs the individual images formed, to the display 3 and the subdisplay 8.

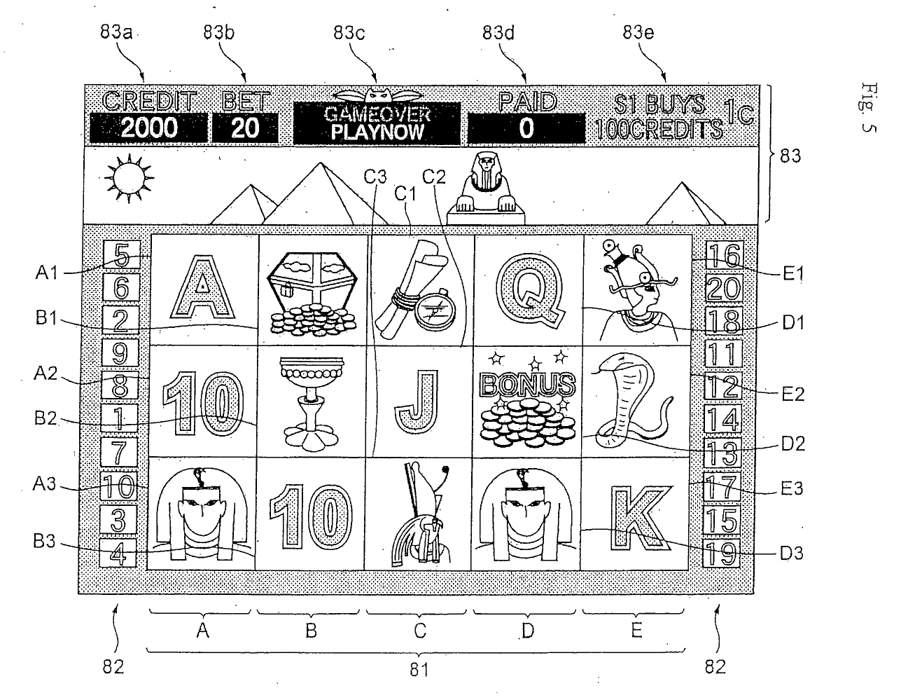

FIG. 5 is a diagram showing a display screen example of the display 3 or the symbol display means. In this embodiment, a display area unit 81, line-number display area units 82 and an upper display area unit 83 are displayed in the display 3.

The display area unit 81 is provided with (five, in this example) display areas A to E or symbol display units each for displaying (e.g., three) symbols. In these display areas A to E, there are so, variably displayed the reel images having symbols of a plurality of kinds that they may rotate. The symbols, which are selected when the individual reel images stop, are processed so that they may be displayed one by one in the individual symbol display areas A1 to A3, B1 to B3, C1 to C3, D1 to D3, and E1 to E3.

On the two sides of the display area unit 81, there are displayed the line number display units 82, which display the line numbers indicating the individual pay lines or the activated lines. Of the line numbers displayed in the line number display units 82, the numbers corresponding to the pay line or the activated line selected by the player are turned on, but the numbers left unselected by the player are turned off.

Over the display area unit 81, there is formed the upper display area unit 83. This upper display unit 83 is composed of a credit number display area 83a, a BET number display area 83b, a letter information display area 83c, a PAID number display area 83d and a fare display area 83e. Here, the credit number display area 83a displays the number of coins being credited, and the BET number display area 83b displays the number of coins bet for one game. Moreover, the letter information display area 83c displays letter information indicating the current state of the game, such as the letter information of the feature game state, when this state comes in. Still moreover, the PAID display area 83d displays the number of coins acquired in one game, and the fare display area 83e displays the CREDIT.

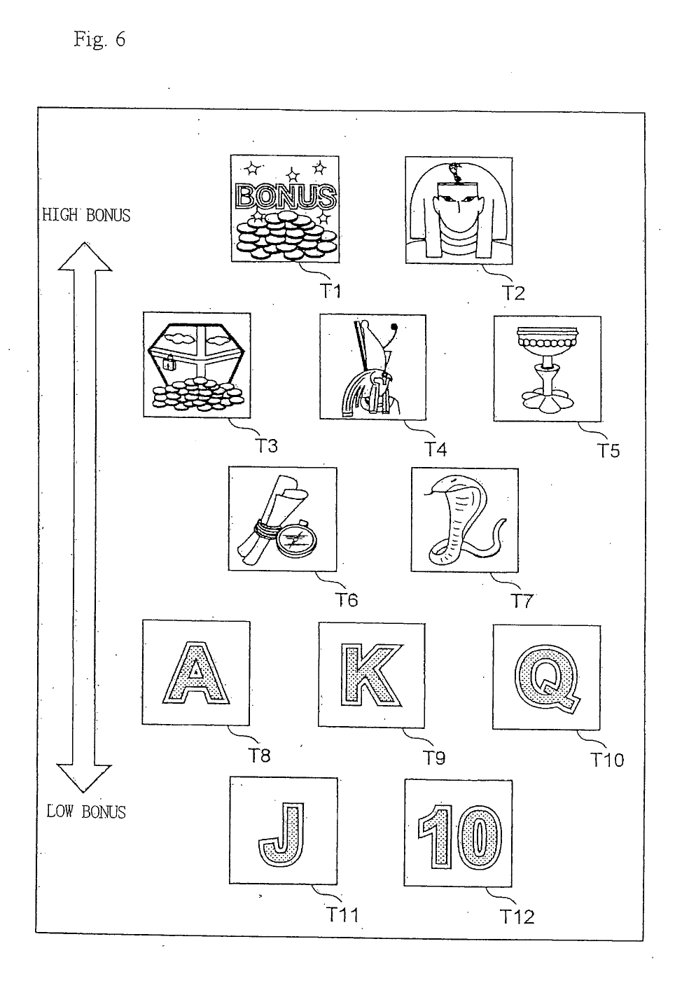

FIG. 6 enumerates the symbols to be displayed in the individual display areas A to E (i.e., the individual symbol display areas A1 to A3, B1 to B3, C1 to C3, D1 to D3, and E1 to E3). The symbols in this embodiment are exemplified: by special symbols, e.g., a bonus symbol T1 and a wild symbol T2; and by base symbols such as a treasure symbol T3, a mask symbol T4, a chalice symbol T5, a map symbol T6, a snake symbol T7, and five kinds of card mark symbols T8 to T12.

The bonus symbol T1 of the special symbol is a symbol (or a scatter symbol) for triggering the rush into the feature game or a second predetermined symbol combination. For example, the game shifts to the feature game, in case a predetermined number of (e.g., four or more) bonus symbols T1 are displayed in the display areas A to E. In this embodiment, the shift to the feature game occurs, if the bonus symbols T1 are displayed in the predetermined number in the display areas A to E no matter where and how they might be displayed or arranged.

On the other hand, the wild symbol T2 or another special symbol is treated as any of the base symbols, that is, the aforementioned treasure symbol T3, mark symbol T4, chalice symbol T5, map symbol T6 and snake symbol T7, and the card mark symbols T8 to T12 of the five kinds. In short, the wild symbol T2 is the so-called “almighty symbol” and can be an element of the combination of the second predetermined symbol combination.

The card mark symbols are the five kinds of the ace symbol (“A”) T8, the king symbol (“K”) T9, the queen symbol (“Q”) T10, the jack symbol (“J”) T11 and the numeral symbol (“10”) T12.

Moreover, the object for the slot machine 1 to display in the symbol display area may also include a blank symbol. This blank symbol may be treated as one kind of symbol to display nothing in the symbol display area, or may be treated as one to be ignored in the determination of a win or a shift to a special game because no symbol exists. The invention can also treat this blank symbol as included in the “symbol”.

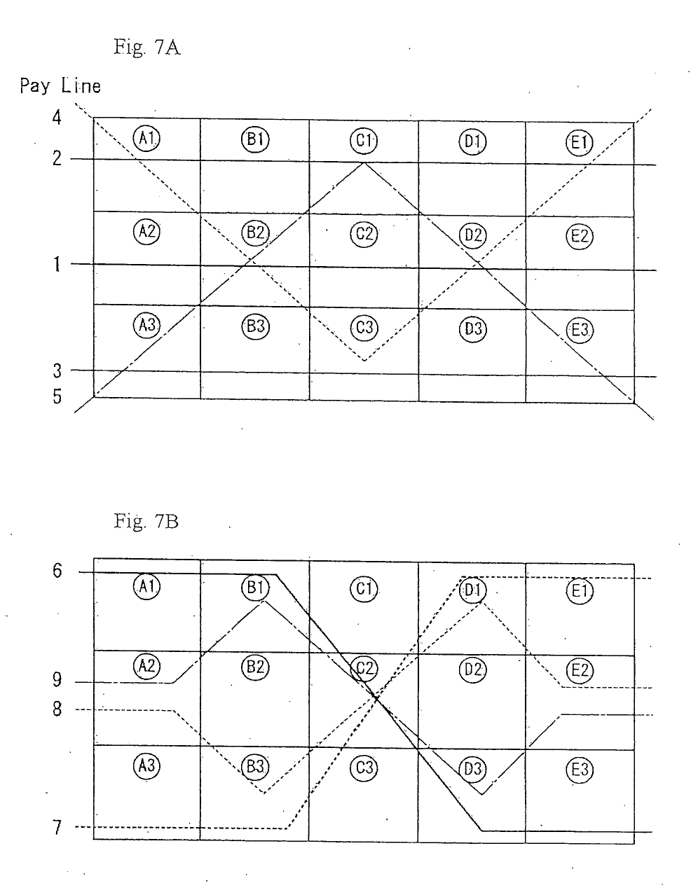

FIG. 7A and FIG. 7B are diagrams showing an example of the pay lines of the slot machine 1. For easy understanding, the pay lines are divided into the two diagrams. For example, nine pay lines are prepared, as shown in the individual diagrams. When a winning combination of symbols or the first predetermined symbol combination is arrayed in any of those pay lines, the bonus corresponding to the contents of the winning symbol combination is paid to the player.

Other eleven pay lines are prepared, although not shown, so that twenty pay lines are prepared in total. Thus, in this embodiment, the display areas corresponding to reels are prepared in rows as many as five, so that various pay lines can be provided.

The win is decided depending upon whether or not a combination of arrayed identical symbols or one example of the first predetermined symbol combination is on such one of the twenty pay lines set in the symbol display areas A1 to A3, B1 to B3, C1 to C3, D1 to D3, and E1 to E3 as designated with the line buttons 6h to 6l by the player. If the combination of identical symbols is aligned on the pay line designated by the player, the main CPU 32 or the determination means decides that the winning condition is satisfied, and causes the payout of a predetermined number of coins.

In this win determination, the wild symbol T2 is decided as the almighty symbol and is treated as a beneficial one for the payout (e.g., the number of coins paid for one coin) in the symbols of the aforementioned ten kinds. Even if the ace symbols T8 and the wild symbols T2 are exclusively arranged in all the symbol display areas of one-pay line, the number of coins paid is identical to that of the case, in which the ace symbols T8 are arranged in all the symbol display areas on one pay line. In this case, the wild symbols T2 are treated as the ace symbols T8 on that pay line.

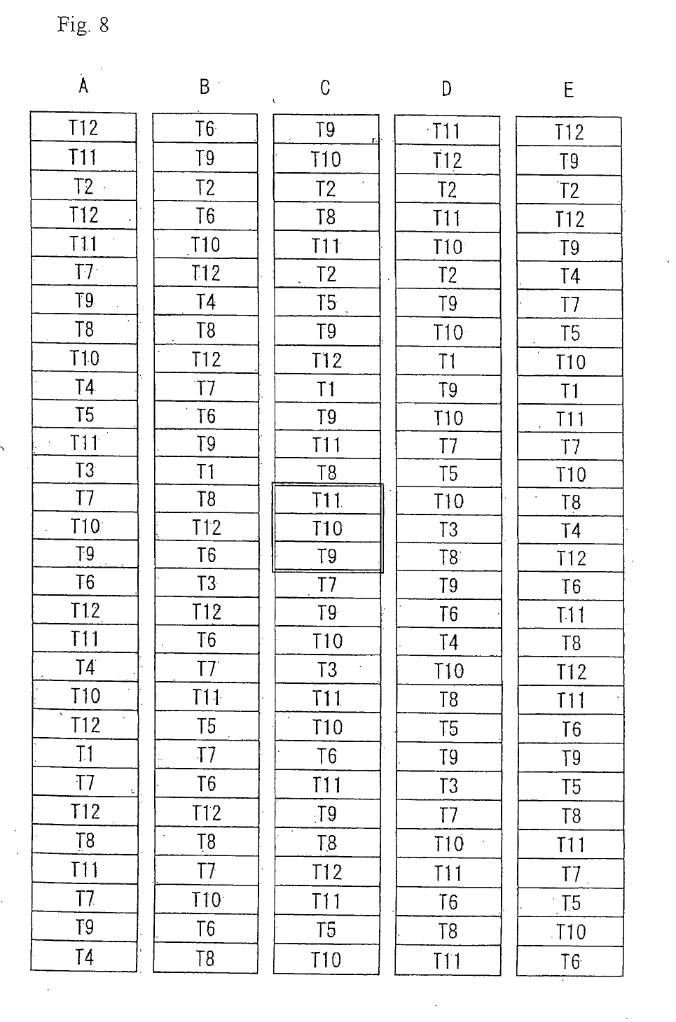

Next, the array of the symbols displayed in the individual display areas A to E is described with reference to FIG. 8. As shown in FIG. 8, thirty symbols arranged in a predetermined sequence are displayed cyclically and variably displayed in the individual display areas A to E. In this embodiment, the scroll display is adopted as the variable display, but this variable display may use a display method other than the scroll display.

By this scroll display, the player is enabled to recognize the symbols as if the mechanical reels were rotated to vary the symbols. The individual display areas A to E may display the symbols by scrolling them for equal periods or for different periods.

For the slot machine 1 according to this embodiment, there are prepared in the progress of the game a base game state corresponding to the base play mode, and a bonus game state corresponding to a special play mode.

Here, the bonus game of this embodiment will be called the “feature game”. This feature game is one example of the bonus game, and the bonus game of the invention should not be limited to the feature game to be described hereinafter.

In the slot machine 1 according to this embodiment, the main CPU 32 of the microcomputer 31 decides whether or not the feature game occurrence condition is satisfied. In case this feature game occurrence condition is satisfied, the main CPU 32 shifts the play mode from the base game state to the feature game state. The main CPU 32 further decides whether or not the feature game continuation condition on the continuation of the feature game state at the end of the feature game is satisfied. In case this feature game continuation condition is satisfied, the main CPU 32 continues or adds the feature game.

In this embodiment, the aforementioned feature game occurrence condition and feature game continuation condition are decided according to the display of a predetermined number of bonus symbols T1 in the display areas A to E. However, the feature game occurrence condition and the feature game continuation condition should not necessarily be limited to the examples of this embodiment but may be arbitrarily set. Moreover, the feature game occurrence condition and the feature game continuation condition need not always be identical but may be independent of each other.

Here, the percentage of payout of the coins in the feature game state (including the continuation time) is set higher than that of the coin payout in the base game state. In other words, this feature game state is very beneficial on the coin payout than in the base game state. As a result, the player plays the base game and the feature game while expecting the shift to the feature game and the continuation of the feature game.

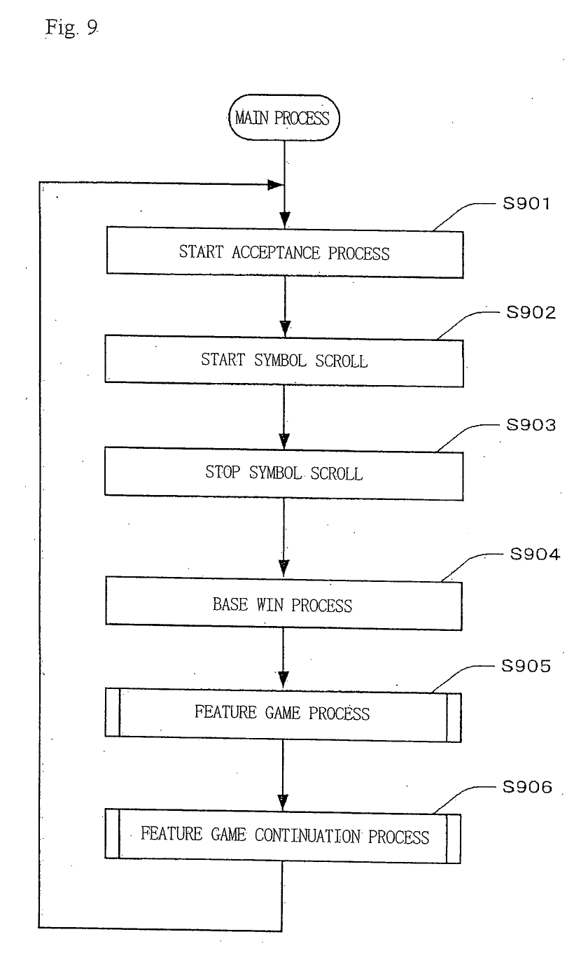

Here is described a method for controlling the slot machine 1 according to this embodiment. FIG. 9 is a flow chart showing one example of the actions of the slot machine 1.

When the main process is started, the slot machine 1 at first executes a start acceptance process (at S901) for starting the game. Specifically, the main CPU 32 accesses to the ROM 34. The ROM 34 transfers the information on the fundamental screen such as the frame to be displayed in the display 3, to the image control circuit 71, and this image control circuit 71 once stores the received information in the video RAM 71e and displays the information in the display 3. As a result, the player can play the slot game serviced by the slot machine 1.

The succeeding routine is realized such that the main CPU 32 executes the programs stored in the ROM 34 and the RAM 33. Here, the slot machine 1 is caused, when started by turning on the main switch, to execute the base game as the slot game.

At this Step S901, the slot machine 1 awaits the BET operation (e.g., to insert coins or to push the bet button) of the player. Specifically, the slot machine 1 starts the base game when coins of a number to be bet for one game are inserted into the coin insertion slot 6 or when the betting buttons 6c to 6g are pushed with the credits being stored in the slot machine 1. When the base game is started, the symbols displayed in the individual display areas A to E are scrolled (at Step S902). At this time, the main CPU 32 controls the image control circuit 71 to execute the image processing as if the mechanical reels were rotating. Moreover, the main CPU 32 makes use of the random number values sent from the sampling circuit 36 to determine the symbols to be displayed in the individual symbol display areas A1 to A3, B1 to B3, C1 to C3, D1 to D3, and E1 to E3 after the variable displays were stopped, and stops the scroll display and shifts it to the variable stop state. After the shift to the variable stop state, the display 3 performs the symbol scroll stop (at Step S903) to display the determined symbol in the corresponding symbol display area.

After the symbol scroll stop (at Step S903), the main CPU 32 execute the base win process (at Step S904). Specifically, the main CPU 32 decides whether or not the symbols displayed in the symbol display areas in the stop display state are in the predetermined symbol combination or the base winning combination on at least one activated line. In case the displayed symbols are in the predetermined symbol combination or the base winning combination, the main CPU 32 either pays out the coins in the number corresponding to the base winning combination or adds the value of the credits corresponding to that base winning combination, to the inserted or acquired credit value stored in the slot machine 1.

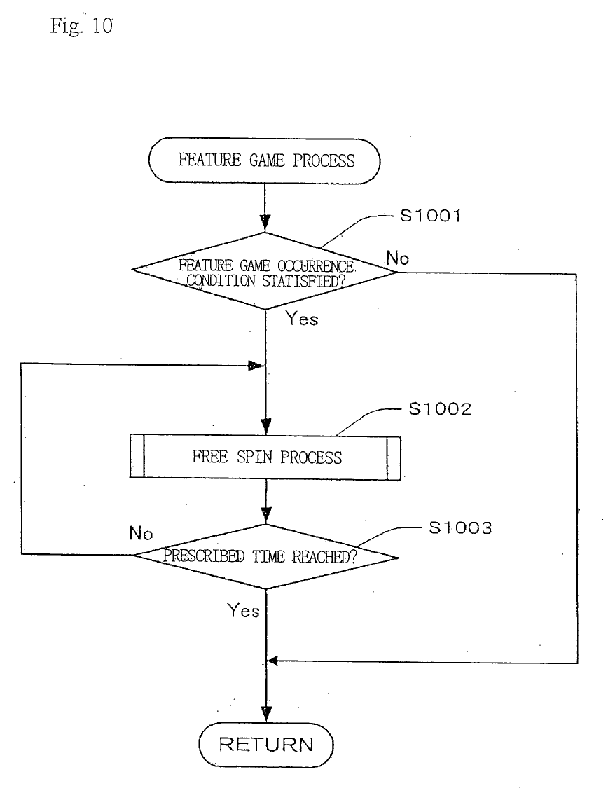

Subsequent to the base win process (at Step S904), the main CPU 32 executes a feature game process (at Step S905). FIG. 10 presents a flow chart showing one example of the feature game process. An example of the feature game process is described with reference to FIG. 10.

When the process is shifted to the feature game process, the main CPU 32 or the shift determination means decided (at Step S1001) whether or not the feature game occurrence condition is satisfied. In this determination, the main CPU 32 decides it as a satisfaction of the feature game occurrence condition that four or more bonus symbols T1 are displayed in the individual display areas A to E of the display 3, specifically, in the individual symbol display areas A1 to A3, B1 to B3, C1 to C3, D1 to D3, and E1 to E3. In case the number of the bonus symbols T1 is three or less, on the contrary, it is decided that the condition for the feature game occurrence is dissatisfied.

In case the main CPU 32 decided the dissatisfaction of the feature game occurrence condition (that the answer of Step S1001 is No), the main CPU 32 ends the feature game process and returns the control to the main process (of FIG. 9).

In case, on the contrary, the main CPU 32 or the shift determination means decides that feature game occurrence condition is satisfied (that is, the answer of Step S1001 is Yes), it shifts the game state of the slot machine 1 from the base game state or the base play mode to the feature game state or the special play mode. In short, the main CPU 32 starts a free spin process (of Step S1002).

The slot machine 1 having started the execution of the free spin process (of Step S1002) performs free spins of a predetermined number (e.g., 10 in this embodiment). In this embodiment, the state of a feature game (excepting the feature games at the continuing time) is to execute ten free spins.

In the execution of each free spin, a process like that at the symbol scroll start (of Step S902) and a process like that of the symbol scroll stop (of Step S903) are performed without the insertion of coins and the pushing of betting buttons 6c to 6g, that is, without consuming the coins or stored credits by the player. In the feature game (or in each free spin), therefore, the player can receive the payout of coins or credits without consuming them, so that the player takes high advantages in the acquisitions of coins or credits.

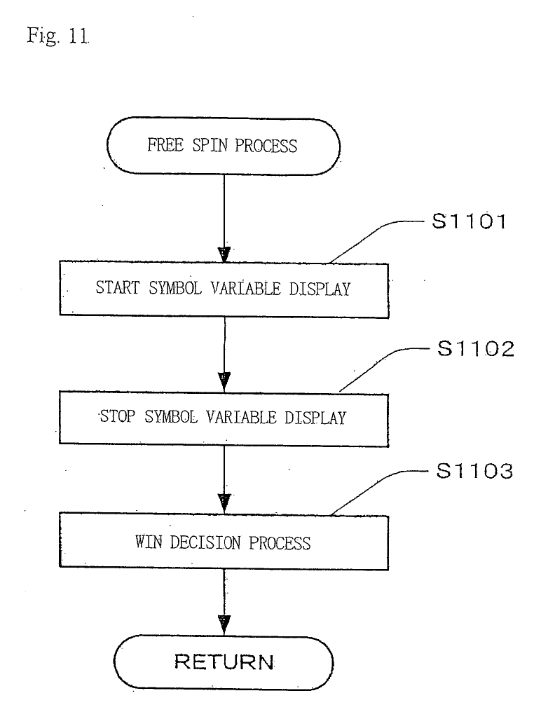

FIG. 11 shows an example of the free spin process (of Step S1002) according to this embodiment. One example of the feature game execution process is described in the following with reference to FIG. 11.

When the free spin process is started, the main CPU 32 executes a symbol variable display start (of Step S1101) like the symbol scroll start (of Step S902) in response to a predetermined operation of the player. For this symbol variable display start, it is unnecessary to insert the coins or to push the betting buttons 6c to 6g. In other words, the player is given a chance for acquiring coins without consuming the coins or stored credits.

Subsequent to the symbol variable display start (of Step S1101), the main CPU 32 executes a symbol variable display stop (of Step S1102) like the aforementioned symbol scroll stop (of Step S903). In this symbol variable display stop (of Step S1102), the main CPU 32 determines the symbols to be displayed in the display areas A to E in the stopped variable display state, and displays the determined symbols (as called the “stop symbols”) individually in the display areas A to E.

In case the stop symbols displayed in the individual display areas A to E contain a predetermined symbol combination (e.g., the base winning combination), the main CPU 32 then calculates either the number of coins to be paid to the player or the credit number to be newly added to the owned one of the player in accordance with the combination, and executes a win determination process (at Step S1103) to instruct the hopper drive circuit 63 to eject the coins of the calculated number or to add the credit value.

When the processes from Step S1101 to Step S1103 are executed, one free spin is ended. Finishing the description of the free spin process (of Step S1002), the description is returned to the feature game process (of FIG. 10).

If the free spin process (of Step S1002) ends in the feature game process (FIG. 10), the main CPU 32 decides (at Step S1003) whether or not the free spins or the condition for ending the feature game have been executed a predetermined number of times. In case the determination reveals that the execution is not made the predetermined times (that is, the answer of Step S1003 is No), the main CPU 32 returns to the free spin process (of Step S1002). In case the execution is made the predetermined times (that is, the answer of Step S1003 is Yes), the main CPU 32 ends the feature game process and returns the control to the main process (of FIG. 9). The description of the feature game process is thus ended.

Next, the description of the main process is reopened with reference to FIG. 9.

When the feature game process is ended, the main CPU 32 executes a feature game continuation process (of Step S906). Here, this feature game continuation process (of Step S906) is executed, only in case the feature game process (of Step S905) has been executed, but is otherwise skipped.

In the feature game continuation process, it is decided at the end of the special play mode whether or not the special play mode is to be continued, and the special play mode is continued according to the result of a lottery.

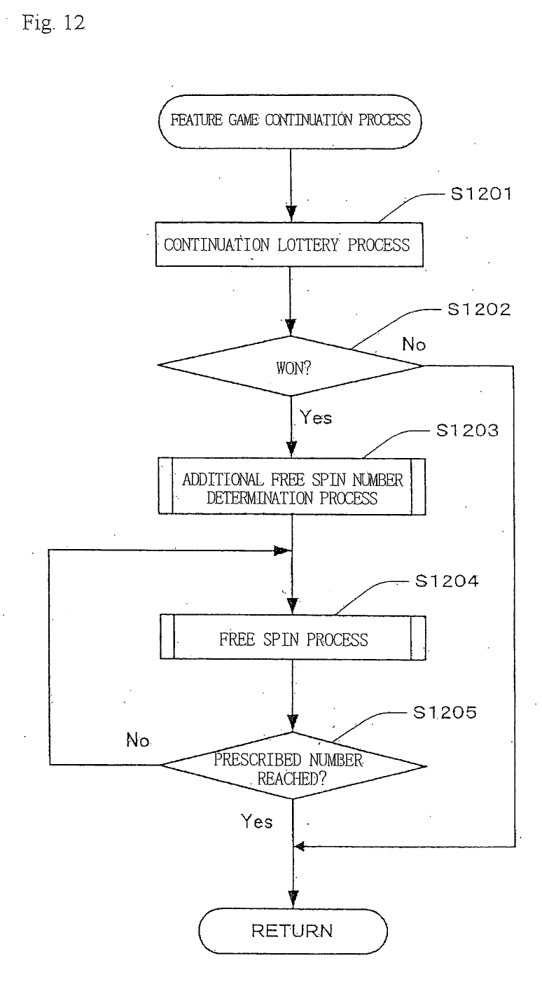

FIG. 12 shows one example of the feature game continuation process (of Step S906). One example of the feature games continuation process is described in the following with reference to FIG. 12.

When the feature game continuation process is started, the main CPU 32 or the continuation determination means executes at first a continuation lottery process (of Step S1201). This continuation lottery process is one for a lottery whether or not the feature game is to be continued.

The lottery method may be any if it can be executed by the slot machine 1. In the free spin before execution of the continuous lottery process, for example, a win may be determined if predetermined symbols such as the bonus symbols T1 are displayed a predetermined number in the display areas A to E. Alternatively, random numbers are separately extracted from the random number generator 35 and the sampling circuit 36 independently of the stop symbols displayed in the display areas A to E, and a win is determined in case the random numbers take any values of 1 to 255, for example, if the extracted value is any of 1 to 9.

Subsequent to the continuous lottery process (of Step S1201), the main CPU 32 decides the lottery result (at Step S1202). The main CPU 32 continues the feature game, in case the lottery is won in the result of the continuous lottery process (of Step S1201), but otherwise ends the feature game and returns the play mode to the base one to service the base game to the player.

In case the main CPU 32 decides that the lottery is not won (that is, the answer of Step S1202 is No), the main CPU 32 ends the feature game continuation process and returns to the main process (of FIG. 9). In short, in case the lottery is not won, the feature game is not continued, but the play mode of the slot machine 1 returns the base game sate in the base play mode.

In case, on the contrary, the main CPU 32 is decided that the lottery is won (that is, the answer of Step S1202 is Yes), the main CPU 32 or the continuation determination means executes an additional free spin number determination process (of Step S1203). The additional free spin number determination process determines, after the end of the free spins or the feature games of a predetermined number, how many free spins are added and serviced for the player.

According to this process of Step S1203, the number of free spins or the contents of the continuation/addition of the bonus game, if any, is not determined in the same manner but can give great benefits, as the case may be, thereby to enhance the playing intention of the player.

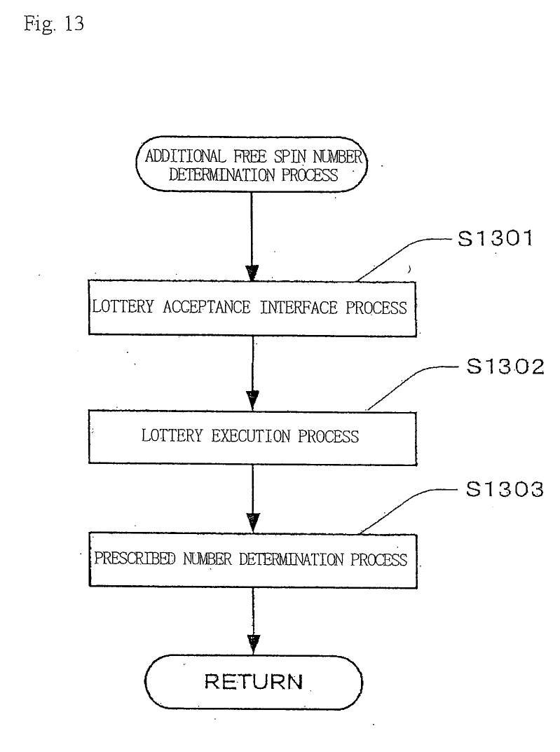

FIG. 13 shows one example of the additional free spin number determination process. One example of the additional free spin number determination process is described in the following with reference to FIG. 13.

When the additional free spin number determination process is started, the main CPU 32 executes a lottery acceptance interface process (of Step S1301) or the process for causing the display 3 or the subdisplay 8 to display the interface (as called the “lottery acceptance interface”) to be presented to the player, when it causes the image control circuit 71 to lot for determining the additional free spin number.

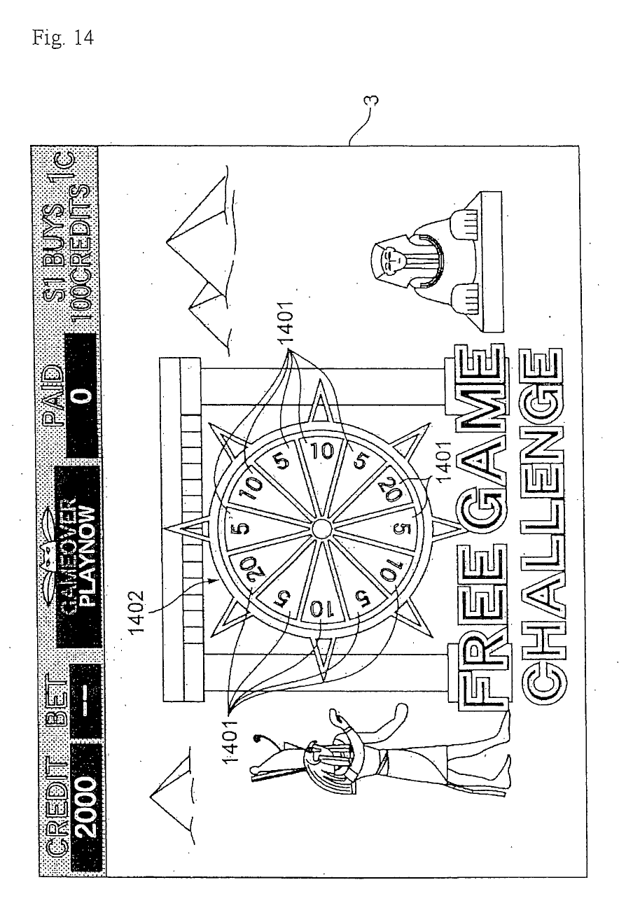

FIG. 14 shows an example of the lottery acceptance interface to be displayed in the display 3 by the lottery acceptance interface process. In this example, a roulette wheel 1402 having small areas 1401 displaying any of additional numbers “5”, “10” and “20”) is displayed at first in a stopped state.

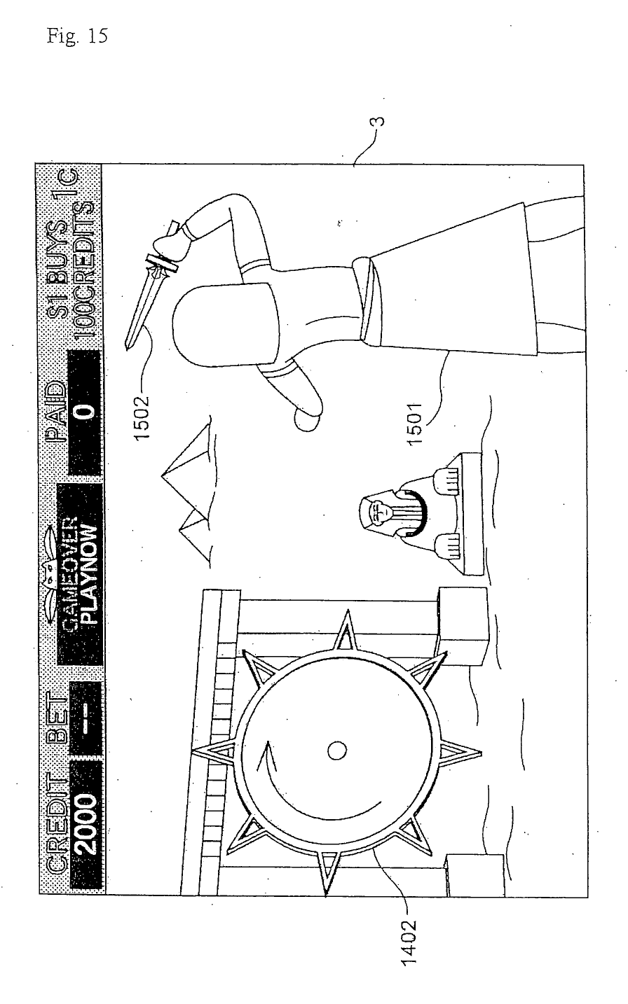

FIG. 15 is an example of the screen transited from the screen of FIG. 14 and shows a screen forming part of the lottery acceptance interface. In the screen of this example, the viewpoint is so moved from the state of FIG. 14 that a human character 1501 or the avatar of the player is going to throw a small sword 1502 toward the roulette wheel 1402. At this time, the roulette 1402 has started its rotation. In this example, it is assumed that the process to that displaying the screen shown in FIG. 15 is the lottery acceptance interface process.

When the lottery acceptance interface process (of Step S1301) is ended, the main CPU 32 or the continuation determination means executed the lottery execution process (at Step S1302). This lottery execution process is one for a lottery to determine the additional free spin number. In this example, when a predetermined event such as the lapse of a predetermined time period (e.g., 3 seconds) or the pushing of a button by the player occurs, the lottery method may be performed such that the main CPU 32 extracts a random number from the random number generator 35 or the sampling circuit 36 thereby to determine the number of addition in accordance with the value of the random number. In case the value of the random number to be taken within a range of 1 to 255, for example: the additional number may be set to “5” if the extracted random number is any of 1 to 128; the additional number may be set to “10” if the extracted random number is any of 129 to 214; and the additional number may be set to “20” if the extracted random number is any of 215 to 255.

The main CPU 32 executes the lottery execution process thus far described and causes the display 3 to display (although not shown) the effect to perform the action, in which the human character 1501 or the abator of the player throws the small sword 1502 toward the roulette wheel 1402.

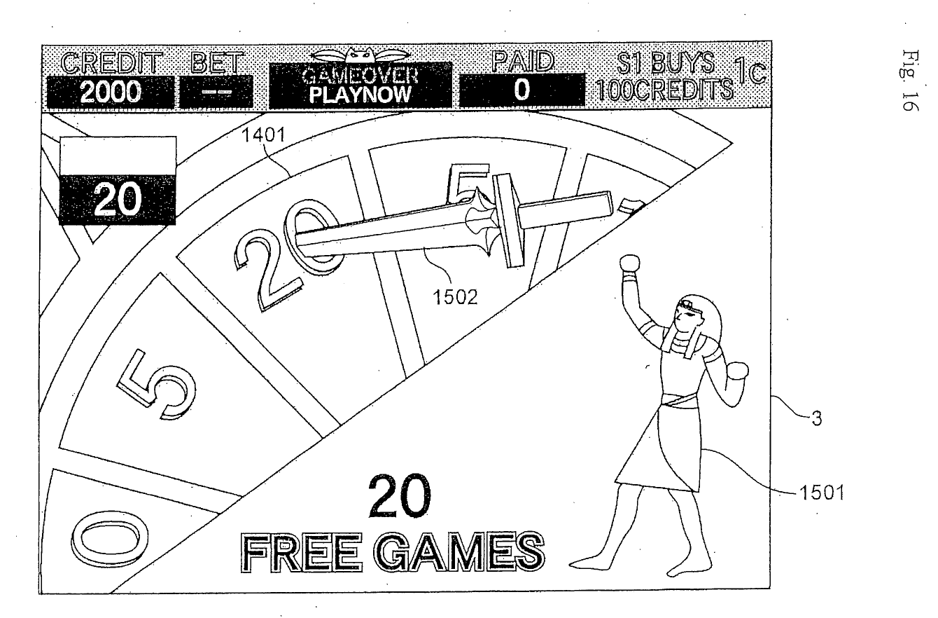

FIG. 16 shows an example of the screen, which displays the lottery result after the aforementioned effect in the display 3 when the main CPU 32 ends the lottery execution process (of Step S1302). In the effect of this example to inform the player of the lottery result, the small sword 1502 thrown by the aforementioned human character 1501 goes home into the small area 1401 of the roulette wheel 1402, i.e., the small area 1401 displaying a numerical value corresponding to the additional number determined by the lottery execution process.

By this effect, the player is informed of the fact that twenty free spins are given as the continuation of the feature game.

The main CPU 32 performs a prescribed number determination process (of Step S1303) to store the additional number determined by the lottery execution process. Thus, the main CPU 32 ends the additional free spin number determination process, and returns the control to the feature game continuation process (of FIG. 12). The description of the additional free spin number determination process is thus ended.

Reverting to FIG. 12, the description of the feature game continuation process is reopened.

When the additional free spin number determination process (of Step S1203) is ended, the main CPU 32 executes a free spin process (at Step S1204). This free spin process has contents like those of the free spin process (of Step S1002) of FIG. 10 so that its description is omitted.

When this free spin process (of Step S1204) ends, the main CPU 32 decides (at Step S1205) whether or not the free spins are executed a prescribed number of times. Here, the prescribed number of times is exemplified by the number of additional times stored at the aforementioned Step S1303.

In case the determination result of Step S1205 has revealed that the prescribed number of times is not reached (that is, the answer of Step S1205 is No), the main CPU 32 returns to the free spin process (of Step S1204). In case, on the contrary, the prescribed number of times is reached (that is, the answer of Step S1205 is Yes), the main CPU 32 ends the feature game continuation process (of FIG. 12), and returns the control to the main process (of FIG. 9). The description of the feature game continuation process is thus ended.

Reverting to FIG. 9, the description of the main process is reopened. When the aforementioned feature game continuation process (of Step S906) is ended in the main process, the main CPU 32 returns again to the start acceptance process (of Step S901), and then repeats the processes of S901 to S906.

The description of one example of the main process of the slot machine 1 according to the first embodiment is thus ended.

### 2. Second Embodiment

Here is described a second embodiment according to the invention.

The second embodiment is proposed as a slot machine, in which the bonus game is realized by the stop symbols or the result of the base game and the free spins. In this slot machine proposed, the number of free spins is drawn in a lottery during the bonus game so that the free spins of the number determined by the lottery are executed. Depending on the result of the free spins, a shift to the bonus game can be made again so that the bonus games can be cyclically played.

(2.1 Fundamental Configuration or the Like of Slot Machine According to the Embodiment)

The fundamental configuration of the slot machine according to this embodiment is similar to that of the slot machine 1 according to the first embodiment. Specifically, the description of the slot machine according to this embodiment is common in the portions relating to the description from FIG. 1 to FIG. 8 so that its detail is omitted.

In the slot machine according to this embodiment, there are prepared in the progress of the game: a base game state corresponding to the base game mode; a free spin state; a first bonus game state corresponding to the first special play mode; and a second bonus game state corresponding to the second special play mode. Here in this embodiment, the first bonus game state is the execution of the free spin state of a prescribed number of times.

(2.1 Action Examples of the Slot Machine According to the Embodiment)

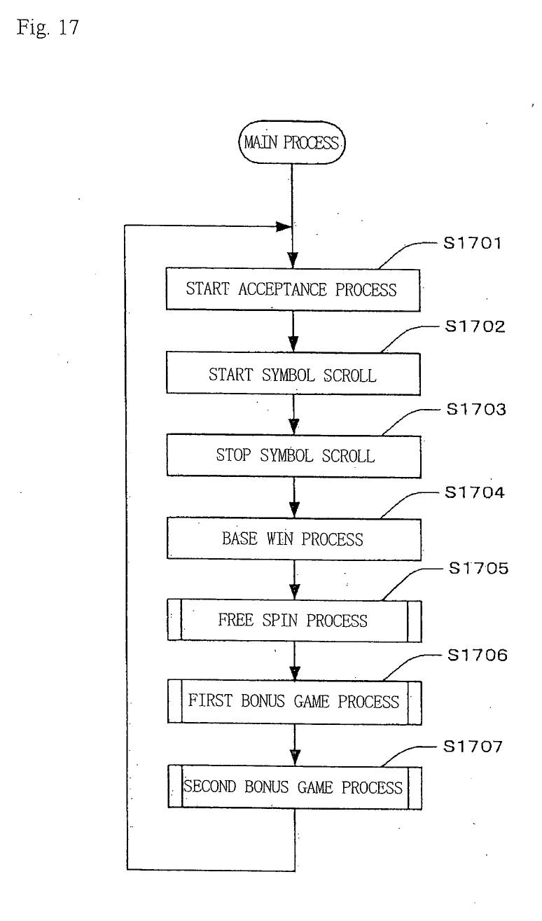

Here is described the action example of the slot machine according to this embodiment. FIG. 17 is a flow chart showing one example of the actions of the slot machine according to this embodiment.

When the slot machine starts the main process, the main CPU 32 executes a start acceptance process (at Step S1701), a symbol scroll start (at Step S1702), a symbol scroll stop (at Step S1703) and a base win process (at Step S1704) consecutively. The start acceptance process (of Step S1701), the symbol scroll start (of Step S1702), the symbol scroll stop (of Step S1703) and the base win process (of Step S1704) shown in FIG. 17 are similar to the start acceptance process (of Step S901), the symbol scroll start (of Step S902), the symbol scroll stop (of Step S903) and the base win process (of Step S904) so that the detailed descriptions of the contents of the individual steps are omitted.

(2.1.1 Free Spin Process)

After the base win process (of Step S1704), the main CPU 32 executes the free spin process (at Step S1705). In the second embodiment, the “free spin” process performs the variable display to the variable stop of symbols without inserting neither coins or credits as an equivalents for the play, so that the payout of the coins/credits, the re-execution of the free spins, the shift to the first bonus game and the shift to the second bonus game are carried out according to the results of the combination of symbols displayed at the variable stopping time.

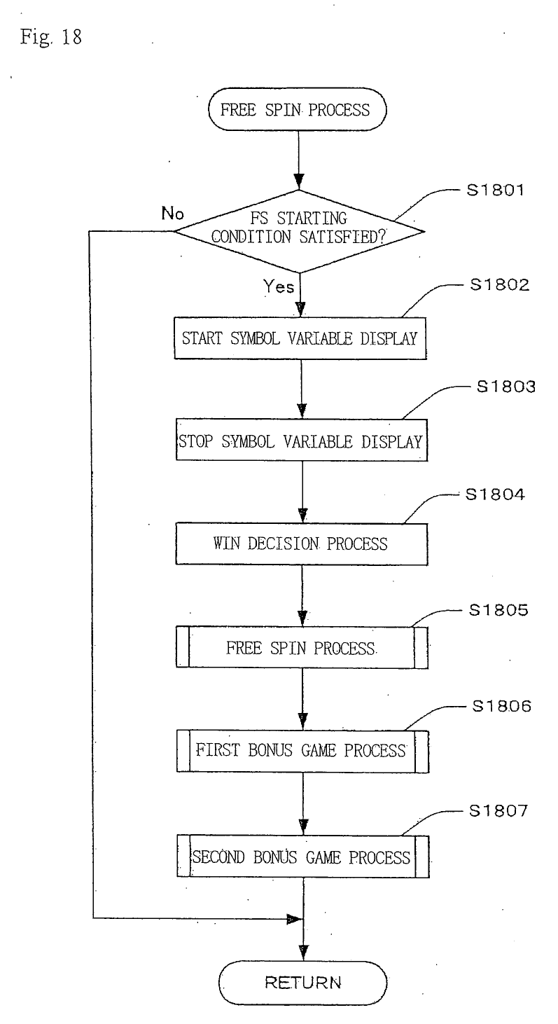

FIG. 18 is a flow chart showing one example of the free spin process in the second embodiment. One example of the free spin process is described in the following with reference to FIG. 18.

When free spin process is started, the main CPU 32 decides at first (at Step S1801) whether or not the free spin starting condition is satisfied. The free spin starting condition is exemplified by that predetermined symbols (e.g., the map symbols T6) are displayed in a predetermined number or more in the individual display areas A to E of the display 3, more specifically, in the individual symbol display areas A1 to A3, B1 to B3, C1 to C3, D1 to D3 and E1 to E3. This free spin starting condition is stored in advance in the ROM 34 or the like, so that the main CPU 32 decides the satisfaction or dissatisfaction of the condition by examining the stop symbols at the time of the variable display stop of the symbols.

In case the main CPU 32 decides at Step S1801 that the free spin starting condition is dissatisfied (that is, the answer of Step S1801 is No), the main CPU 32 ends the free spin process and returns the control to the main process.

In case, on the contrary, the main CPU 32 decides at Step S1801 that the free spin starting condition is satisfied (that is, the answer of Step S1801 is Yes), the main CPU 32 executes a symbol variable display start (at Step S1802) like a process similar to that of the symbol scroll start (of Step S1702) in response to a predetermined operation of the player such as the push of a start lever. At the symbol variable display start, it is not necessary to insert the coins or to push the betting buttons 6c to 6g. In other words, the player is given a chance to acquire the coins without consuming the coins or the stored credits.

Subsequent to the aforementioned symbol variable display start (S1802), the main CPU 32 executes a symbol variable display stop (of Step S1803) like the aforementioned symbol scroll stop (of Step S1703). At the symbol variable display stop (of Step S1803), the main CPU 32 determines such symbols on the basis of random numbers as are individually displayed on the display areas A to E in the variable display stopped state, and displays the determined symbols (as called the “stop symbols”) individually in the display areas A to E.

Next, the main CPU 32 performs such a win determination process (at Step S1804), in case the stop symbols displayed individually in the display areas A to E contain a predetermined symbol combination (e.g., a base winning combination), as to calculate either the number of coins to be paid out to the player in accordance with that combination or the number of credits to be newly added to the credit number owned by the player, and as to instruct the hopper drive circuit 63 either to inject the coins of the calculated number or to add the credit values.

Subsequently, the main CPU 32 starts the free spin process (at Step S1805) newly, in case the stop symbols displayed individually in the display areas A to E contain the predetermined symbol combination corresponding to the free spin starting condition. In this case, it looks to the player as if the free spin state were continued. In case the stop symbol does not contain the predetermined symbol combination corresponding to the free spin starting condition, the routine advances directly to the first bonus game process.

Subsequent to the free spin process (of Step S1805), the main CPU 32 executes a first bonus game process (of Step S1806) and a second bonus game process (at Step S1807) sequentially. The contents of the first bonus game process (of Step S1806) and the second bonus game process (of Step S1807) to be executed in the free spin process are identical to those of the processes (of Step S1706 and Step S1707) in the main process. Therefore, the contents of those processes (of Step S1706 and Step S1707) are described in the description of the main process. After the end of the second bonus game process (of Step S1807), the main CPU 32 ends the free spin process and returns the control to the main process.

Reverting to FIG. 17, the main process is described.

(2.1.2. First Bonus Game Process)

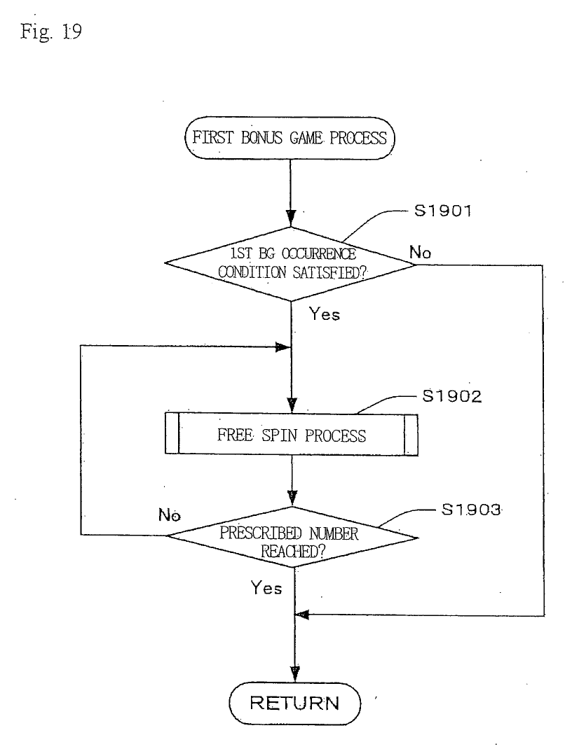

When the free spin process (of Step S1705) is ended, the main CPU 32 starts the first bonus game process (at Step S1706) FIG. 19 presents a flow chart showing one example of the first bonus game process. An example of the first bonus game process is described in the following with reference to FIG. 19. Here in this embodiment, the first bonus game is one having contents like those of the feature game of the first embodiment, but this is not intended to limit the invention to such game mode.

When the process is shifted to the first bonus game process, the main CPU 32 decides at first (at Step S1901) whether or not the first bonus game occurrence condition is satisfied. In this determination, the main CPU 32 decides the satisfaction of the first bonus game occurrence condition, in case the number of the bonus symbols T1 displayed in the individual display areas A to E of the display 3, specifically, in the individual symbol display areas A1 to A3, B1 to B3, C1 to C3, D1 to D3 and E1 to E3 is four or more, and the dissatisfaction of the first bonus game occurrence condition, in case the number of the displayed bonus symbols T1 is three or less.

The main CPU 32 ends the first bonus game process and returns the control to the main process (of FIG. 17), in case it decides that the first bonus game occurrence condition is dissatisfied (that is, the answer of Step S1901 is No).

In case, on the contrary, the main CPU 32 decides that the first bonus game occurrence condition is satisfied (that is, the answer of Step S1901 is Yes), it shifts the game state of the slot machine 1 from the base game state or the base play mode to the first bonus game state or the special play mode. Specifically, the main CPU 32 starts the process to repeat a free spin process (of Step S1902) a prescribed number of times. Here, the free spin process has contents identical to those of the aforementioned free spin processes (of Step S1705 and Step S1805). In this embodiment, more specifically, in the first bonus game state, the execution of ten free spin processes is set to the execution of one first bonus game.

When the free spin process (of Step S1902) is ended, the main CPU 32 decides (at Step S1903) whether or not the free spins or the condition for ending the first bonus game has been executed a prescribed number of times. In case the determination reveals that the executions of the prescribed number of times are not made (that is, the answer of Step S1903 is No), the main CPU 32 returns to the free spin process (of Step S1902). In the case of the execution of the prescribed number of times (that is, the answer of Step S1903 is Yes), on the contrary, the main CPU 32 ends the first bonus game process and returns the control to the main process (of FIG. 17). The description of the first bonus game process is thus ended.

In this embodiment, the free spin process (of Step S1902) in the first bonus game is given process contents similar to those of the remaining free spin processes (of Step S1705 and Step S1805). In the first bonus game, therefore, there can occur: the re-execution of the free spin process (as referred to Step S1805); the re-execution of the first bonus game (as referred to Step S1806); and the shift to the second bonus game (as referred to Step S1807).

(Second Bonus Game Process)

When the first bonus game process (of Step S1706) is ended, the main CPU 32 starts the second bonus game process (of Step S1707). This second bonus game process is to make, in case the second bonus game occurrence condition is satisfied, the effects: to cause the player to select a plurality of select branches; to give the payout of the variables of an amount according to the branch selected by the player; and to determine the number of free spins to be given as a further award of the second bonus game at a predetermined ratio after that select branch was selected.

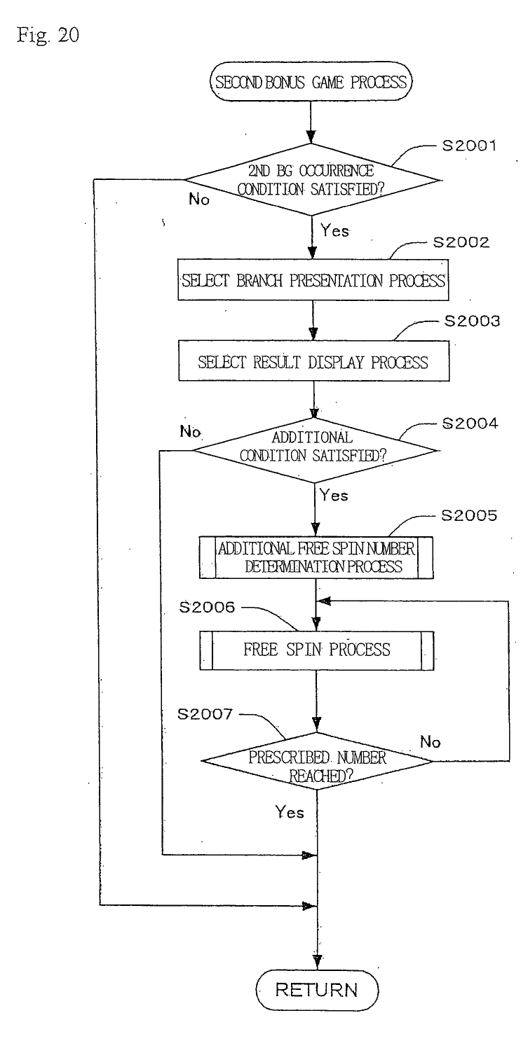

FIG. 20 shows one example of the second bonus game process. This second bonus game process is described in the following with reference to FIG. 20.

When the process is shifted to the second bonus game process, the main CPU 32 decides at first (at Step S2001) whether or not the second bonus game occurrence condition is satisfied. In this determination, the main CPU 32 decides the satisfaction of the second bonus game occurrence condition, in case the number of the second bonus symbols T2 displayed in the individual display areas A to E of the display 3, specifically, in the individual symbol display areas A1 to A3, B1 to B3, C1 to C3, D1 to D3 and E1 to E3 is four or more, and the dissatisfaction of the second bonus game occurrence condition, in case the number of the displayed second bonus symbols T2 is three or less.

The main CPU 32 ends the second bonus game process and returns the control to the main process (of FIG. 17), in case it decides that the second bonus game occurrence condition is dissatisfied (that is, the answer of Step S2001 is No).

In case, on the contrary, the main CPU 32 decides that the second bonus game occurrence condition is satisfied (that is, the answer of Step S2001 is Yes), it shifts the game state of the slot machine 1 to the second bonus game state, and performs a select branch presentation process (of Step S2002).

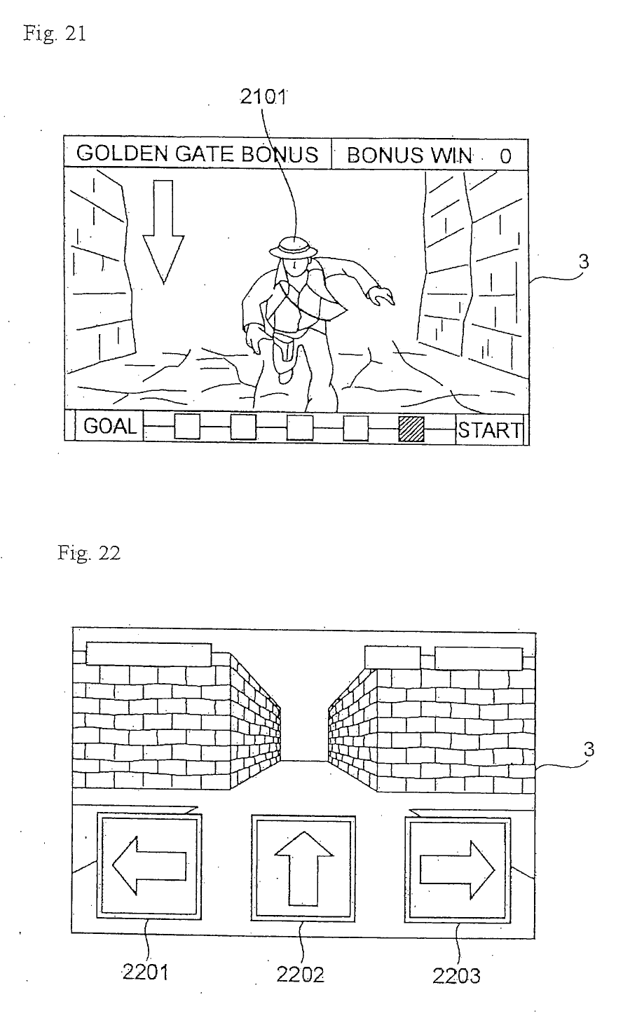

In this embodiment, the select branch presentation process is to present the select branch to the player and to provide a user interface screen for promoting the selection. FIG. 21 and FIG. 22 show an example of the user interface screen to be displayed in the display 3 in the select branch presentation process.

When the select branch presentation process is started, the main CPU 32 instructs the image control circuit 71 to display the user interface screen, as shown in FIG. 21. This user interface screen displays, as an effect, the image, in which a character 2101 or the abator of the player is running to this side on a way.

Subsequent to the screen of FIG. 21, the display contents of the screen are switched so that the user interface screen shown in FIG. 22 is displayed in the display 3. In this example, three paths of escape to be taken by the character 2101 are drawn together with select areas 2201, 2202 and 2203 displaying the directions (leftward, straight and rightward) of the ways of escape to be selected by the player. In this example, it is assumed that the display 3 is provided with the not-shown touch panel sensors so that the player can recognize what of the select areas 2201, 2202 and 2203 is selected by the player, with a detect signal coming from the (not-shown) touch panel sensor, when the player touches any of the select areas with the finger. When the user interface screen shown in FIG. 22 is displayed, the main CPU 32 ends the select branch presentation process (of Step S2002).

When the player touches the select area 2201, 2202 or 2203 to complete the selected input of the select branch, the main CPU 32 executes a select result display process (of Step S2003). The select result display process is one for notifying the player of the select result of the select area, and the player displays the screen according to the select areas 2201, 2202 and 2203 in the display 3.

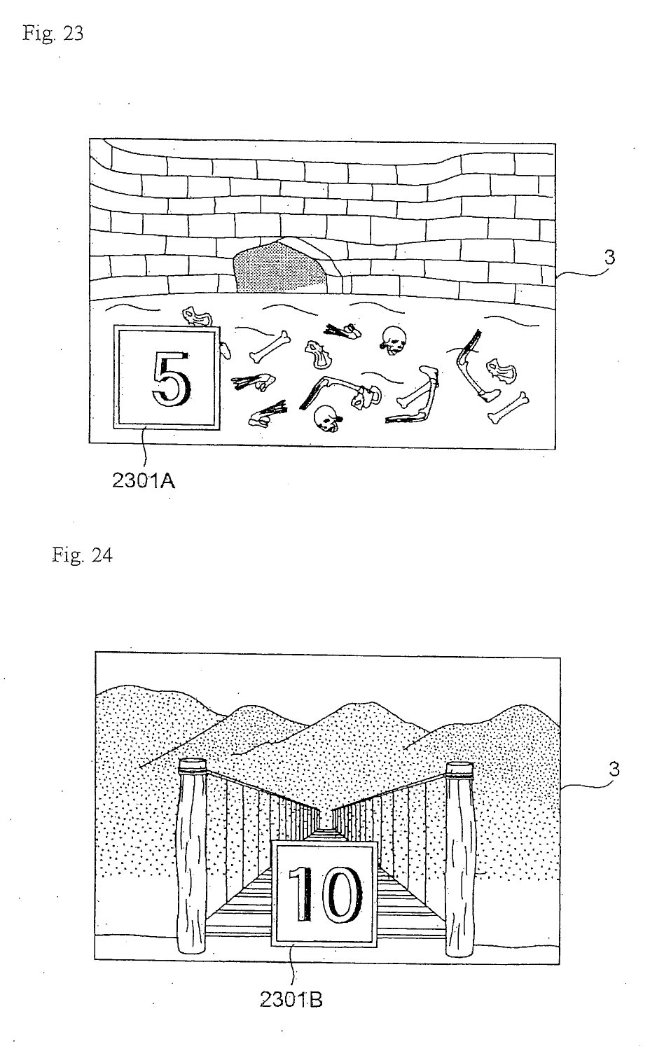

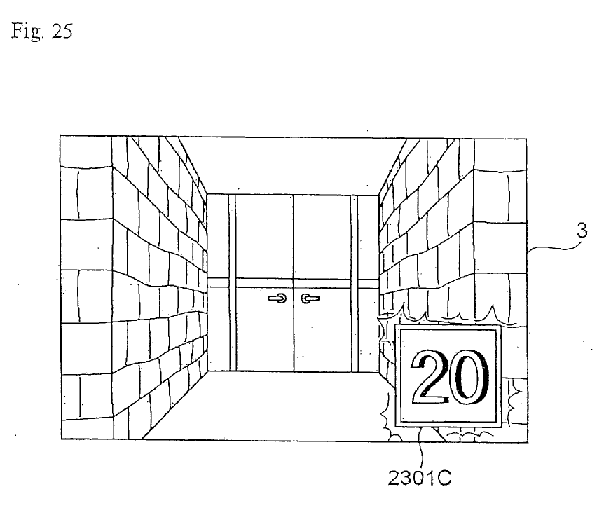

FIG. 23 to FIG. 25 show examples of screens displayed in the select result display process. Here: the screen, in which the result of the selection of the select area 2201 (leftward) by the player is displayed, is shown in FIG. 23; the screen, in which the result of the selection of the select area 2202 (straight) by the player is displayed, is shown in FIG. 24; and the screen, in which the result of the selection of the select area 2203 (rightward) by the player is displayed, is shown in FIG. 25.

The individual screens have award display areas 2301A, 2301B and 2301C, which display the numbers of coins/credits, i.e., the awards to be paid out to the player by the second bonus game, so that the numerals corresponding to the numbers of coins/credits to be paid out are displayed in the individual award display areas 2301A, 2301B and 2301C. The player knows the award sums which cannot be known before the selection, as the results of the second bonus game in view of the award display areas 2301A, 2301B and 2301C. In this example, the player knows it: from the award display area 2301A that five coins/credits are paid out as a small win to the player, in case the select area 2201 or the leftward way of escape is selected; from the award display area 2301B that ten coins/credits are paid out as a medium win to the player, in case the select area 2202 or the straight way of escape is selected; and from the award display area 2301C that twenty coins/credits are paid out as a high win to the player, in case the select area 2203 or the rightward way of escape is selected.

The description of the second bonus game process is continued by reverting to FIG. 20.

The second bonus game of this embodiment not only causes the player to select the select branches thereby to pay out an award according to the select result to the player but also gives the player a chance for acquiring more coins/credits by a lottery. After the select result display process (of Step S2003), specifically, the number of free spins is determined under a condition, and a benefit is given to the player for playing the free spins of that number.

This process is described in more detail. At first, the main CPU 32 decides (at Step S2004) whether or not the free spin start condition is satisfied. This free spin start condition may be satisfied by a predetermined probability such as 1/5. For example, the main CPU 32 may generate a random number of 1 to 100. In case the random number generated is 1 to 20, it may be decided that the free spin starting condition is satisfied. Otherwise, it may be decided that the free spin starting condition is not satisfied. Altetnatively, the satisfaction of the free spin starting condition is decided, in case a big hit (of FIG. 25) is selected in the selection of the aforementioned select branches, but otherwise the dissatisfaction of the free spin starting condition is decided.

In case the dissatisfaction is decided in the free spin starting condition determination process (that is, the answer of Step S2004 is No), the main CPU 32 ends the second bonus game process, and returns the control to the original process.

In case, on the contrary, the satisfaction is decided in the free spin starting condition determination process (that is, the answer of Step S2004 is Yes), the main CPU 32 performs the additional free spin number determination process (at Step S2005). Here, the additional free spin number determination process (of Step S2005) is similar to that (at Step S1203 of FIG. 12, as referred to FIG. 13) in the first embodiment so that its detailed description of the process contents is omitted. Moreover, the screen displayed in the additional free spin number determination process (of Step S2005) is exemplified by the screens, as shown in FIG. 14 to FIG. 16, like that of the additional free spin number determination process in the first embodiment.

Here, the screen (e.g., the screen shown in FIG. 25 in this embodiment) displayed in the select result display process (of Step S2003) and the screens of FIG. 14 and later are so recognized by the player by transiting those screens continuously from the former to the latter, as if they belong to serial ones of the second bonus game. In the effects of FIG. 25, for example, the behaviors, in which a large door 2501 is gradually opened, may be displayed in moving images, and the screen shown in FIG. 14 may be seen in the distance over the opened door and then zoomed up so that it may be displayed in the full screen of the display 3.

When the additional free spin number determination process (of Step S2005) is ended, the main CPU 32 executes a free spin process (of Step S2006). The contents of this free spin process are similar to those of the free spin process (of Step S1705 in FIG. 18) of FIG. 17 so that their description is omitted.

When the free spin process (of Step S2006) ends, the main CPU 32 decides (at Step S2007) whether or not the free spins have been executed a prescribed number of times. The prescribed number of times is exemplified by the value of the additional number stored in the aforementioned additional free spin number determination process (of Step S2005).

In case the result of the determination at Step S2007 reveals that the free spins are not executed the prescribed number of times (that is, the answer of Step S2007 is No), the main CPU 32 returns to the free spin process (of Step S2006). In the case of the execution of the prescribed number of times (that is, the answer of Step S2007 is Yes), on the contrary, the main CPU 32 ends the second bonus game process (of FIG. 20), and returns the control to the original one. The description of the second bonus game process is thus ended.

Reverting to FIG. 17, the description of the main process is reopened. When the second bonus game process (of Step S1707) is ended, the main CPU 32 returns again to the start acceptance process (of Step S1701), and the operations are cyclically repeated from Step S1701 to Step S1707.

The description of the main process and the description of the second embodiment are thus ended.

(2.2 Others)

(1) In this embodiment, as shown in FIG. 18, the free spins can occur in the first and second bonus games, and the executions of the first and second bonus games can also occur in the free spins. Therefore, the state transitions can be made among the free spin, the first bonus game and the second bonus game. For example, the following game state transitions can be made:
(1) Base Game State→Free Spin→First Bonus Game (or Second Bonus Game);
(2) Base Game State→First Bonus Game→Second Bonus Game; and
(3) Free Spin→Free Spin.
   (Modification)

The present invention should not be limited to the foregoing embodiments but can be modified in various manners. Modifications of the invention are exemplified in the following.

(1) In the foregoing first and second embodiments, the slot machine 1 has been described as the slot machine having a video type reel. However, the invention can also be embodied by a slot machine having a mechanical reel.

(2) The foregoing first and second embodiments have been described on the configuration, in which the number of the display areas of the display 3 corresponding to the reel number of the slot machine is 5. However, the number of the reel number/the display areas in the invention should not be limited to 5 but may be increased/decreased, if necessary, to 3 or 9.

(3) In the first embodiment, the lottery for whether or not the feature game or the bonus game is to be continued and the lottery for how many free spins constitute the feature game in case the feature game is continued are drawn separately of each other, but those lotteries may be executed at one time. Specifically, the invention can also be embodied such that the lottery for whether or not the feature game or the bonus game is to be continued is not drawn. In this embodiment, the number of free spins constituting the feature game is 0 to N-times (N: a suitable natural number), but the continuation of the feature game is not made in case the lottery is 0, and a continuation determination process is made.

(4) In the second embodiment, the shifts to the first and/or second bonus games during the free spin may be set to occur in a high probability. In case the numeral symbol “10” (T12) is contained in the stop symbols, for example, the numeral symbol may be changed into either the symbol T1 or the symbol for the condition to start the first bonus game or the symbol T2 or the symbol for the condition to start the second bonus game only at the free spin time thereby to make the occurrence condition decisions (of Step S1901 and Step S2001).

(5) In the second embodiment, there are set two kinds of bonus games, i.e., the first and second bonus games. The bonus games to be prepared in the present slot machine should not be limited to the two kinds, but the invention may naturally have three kinds of or more bonus games.

(6) In the second embodiment, the link of the first and second bonus games could occur, so that the free games of a predetermined number (a first prescribed number) or a prescribed number (a second prescribed number) might newly occur during the execution of the free games of a predetermined number or a prescribed number. In this case, the player may play the feature games of the added number of the number of the unexecuted feature games and the new predetermined or prescribed number.

Although the present invention has been explained in reference to the embodiment(s), it is apparent for those skilled in the art that many changes and modifications can be made without departing from the spirit and scope of the invention, as clear from the following claims.

What is claimed is:

1. A gaming machine comprising:
a symbol display device including a plurality of symbol display units capable of variably displaying a plurality of symbols, for displaying at least one of the plurality of symbols in each of the symbol display units when the variable display is stopped according to a predetermined stop condition;
a shift determination device for determining whether or not the symbols stopped and displayed in each of the symbol display units contain a predetermined symbol combination, to shift, in case the symbols contain the predetermined symbol combination, a play mode from a base play mode into a special play mode, in which the payment of the valuables is made more beneficial than in the base play mode; and
a continuation determination device for determining whether or not the special play mode is to be continued, at the end of the special play mode, to continue the special play mode in accordance with the result of a lottery.

2. A gaming machine according to claim 1,
wherein the special play mode is a plurality of free spins, and wherein the continuation determination device determines, in case the special play mode is continued according to the result of the lottery, the number of free spins to be executed in the continued special play mode, by the lottery.

3. A gaming machine comprising:
a symbol display device including a plurality of symbol display units capable of variably displaying a plurality of symbols, for displaying at least one of the plurality of symbols in each of the symbol display units when the variable display is stopped according to a predetermined stop condition;
a first special play mode execution device for executing a first special play mode, in which the payment of the variables is made more beneficial to the player than in the base play state and which contains the variable displays of a first prescribed number;
a second special play mode execution device for executing a second special play mode, in which the payment of the variables is made more beneficial to the player than in the base play state, which has play contents other than those of the first play mode and which contains the variable displays of a second prescribed number; and
a shift determination device for determining, in the variable display of the first prescribed number or the variable display of the second prescribed number, whether or not the symbols stopped and displayed in each of the symbol display units, in case the symbols contain the predetermined symbol combination, the first special play mode execution device or the second special play mode execution device to execute the first special play mode or the second special play mode in accordance with the predetermined symbols contained.

4. A gaming machine according to claim 3,
wherein the shift determination device decides whether or not the symbols stopped and displayed in each of the symbol display units in the base play state contain a predetermined symbol combination, to shift the play mode from a base play mode to a special play mode for making the payment of the valuables beneficial to the player, in case the symbols contain the predetermined symbol combination, and thereafter shifts the play mode to the first special play state or the second special play state.

5. A gaming machine according to claim 3,
wherein the play contents other than those of the first play mode are to cause the player to select a selection branch thereby to pay a bonus according to the selection result to the player.

6. A gaming machine according to claim 3,
wherein the prescribed number is determined by a lottery.
